(19) United States
(12) Patent Application Publication
(10) Pub. No.: US 2019/0128247 A1
(43) Pub. Date: May 2, 2019

(54) System and Method for a Reciprocating Injection Pump

(71) Applicant: Predominant Pumps & Automation Solutions LLC, Houston, TX (US)

(72) Inventor: Seth A. Douglas, III, Houston, TX (US)

(73) Assignee: Predominant Pumps & Automation Solutions LLC, Houston, TX (US)

(21) Appl. No.: 15/968,870

(22) Filed: May 2, 2018

Related U.S. Application Data
(60) Provisional application No. 62/531,740, filed on Jul. 12, 2017.
(60) Provisional application No. 62/555,016, filed on Sep. 6, 2017.

(51) Int. Cl. F04B 19/04; F04B 19/02; F04B 23/06; F04B 35/04; F04B 39/08; E21B 33/068; F16H 19/04

(52) U.S. Cl. CPC F04B 19/04; F04B 19/022; F04B 23/06; F04B 2203/02; F04B 39/08; E21B 33/068; F16H 19/043; F04B 35/04

(57) ABSTRACT

A reciprocating injection pump is disclosed including but not limited to a reciprocating block driven by a rotating gear, the gear having a substantially circular shape with four gear teeth formed on the rotating gear along approximately one fourth of the substantially circular shape, the rotating gear is attached to a rotating motor, the rotating motor having a right-angle motor shaft.

### CROSS REFERENCE TO RELATED PATENT APPLICATIONS

This patent application claims priority from U.S. Provisional Patent Application Ser. No. 62/555,016 filed on 6 Sep. 2017 by Seth A Douglas entitled A System and Method for a Reciprocating Injection Pump which is hereby incorporated by reference herein in its entirety; and this patent application also claims priority from U.S. Provisional Patent Application Ser. No. 62/531,740 filed on 12 Jul. 2017 by Seth A Douglas entitled A System and Method for a Reciprocating Injection Pump which is also hereby incorporated by reference herein in its entirety.

### BACKGROUND OF THE INVENTION

Oil field pumps wear out and leak causing expensive down time for repair and replacement during oil production.

### Field of the Invention

A system and method for pumping that reduces expensive down time for repair and replacement during oil field production.

### BRIEF DESCRIPTION OF THE DRAWINGS

FIG. 1, is a plan view of an illustrative embodiment of the invention;

FIG. 2, is a plan view of another particular embodiment a processor and computer readable medium having computer instructions stored therein that are executed by the process to control a stepper motor;

FIG. 3, is a plan view of another particular illustrative embodiment of the invention is schematically depicted showing three plungers attached to a right end of a reciprocating block and another three plungers attached to a left end of the reciprocating block;

FIGS. 4A and 4B are plan views of particular illustrative embodiments of the invention is schematically depicted showing six plungers attached to the right end of the reciprocating block and another six plungers attached to the left end of the reciprocating block.

FIG. 5 is a plan view of another particular illustrative embodiment of the invention is schematically depicted showing the reciprocating block drives 12 plungers that are used to drive 12 pumps.

FIG. 6 is a plan view of another illustrative embodiment of the invention a pump head schematically depicted.

FIG. 7A, 7B and 7C are plan views of the packing gland is made up of six packing glands. The six packing glands are geometrically shaped to mate with adjacent packing glands to for a stacked set of six packing glands to form the packing gland set shown in FIG. 5.

FIG. 8 is a plan view of a particular illustrative embodiment of the invention, the sixth packing gland element is a spring-loaded section that is convex on the bottom and flat on the top.

FIGS. 9A and 9B are plan views of another particular embodiment of the invention the plungers drive an injection pump.

FIG. 10 is a plan view of a schematic of a safety ring is attached through an opening in a flat surface on the atomizer.

FIG. 11 is a plan view of a detail schematic of the safety ring is shown.

FIG. 12A is a plan view of a schematic depiction of an illustrative embodiment of a collapsible tank stand setup and deployed and ready to support a tank.

FIG. 12B is a plan view of a schematic depiction of the collapsible tank stand collapsed and folded up for transport.

FIG. 13 is a plan view of a particular illustrative embodiment, a hydraulic injection pump system is schematically depicted having a two-pump combination for providing a low-power consumption electrical solution to pumping injection fluid into a subterranean hydrocarbon-bearing formation;

FIG. 14 is a plan view of a particular illustrative embodiment, a hydraulic injection pump system is schematically depicted having a two-pump combination for providing a low-power consumption electrical solution to pumping injection fluid into a subterranean hydrocarbon-bearing formation; and

FIG. 15 is a plan view of a particular illustrative embodiment, a hydraulic injection pump system is schematically depicted having a two-pump combination for providing a low-power consumption electrical solution to pumping injection fluid into a subterranean hydrocarbon-bearing formation.

### SUMMARY OF THE INVENTION

A reciprocating injection pump is disclosed including but not limited to a reciprocating block driven by a rotating gear, the gear having a substantially circular shape with four gear teeth formed on the rotating gear along approximately one fourth of the substantially circular shape, the rotating gear is attached to a rotating motor, the rotating motor having a right-angle motor shaft.

### DETAILED DESCRIPTION OF THE INVENTION

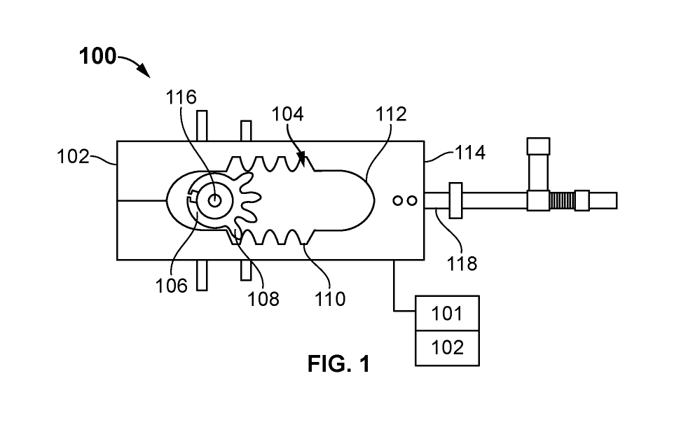

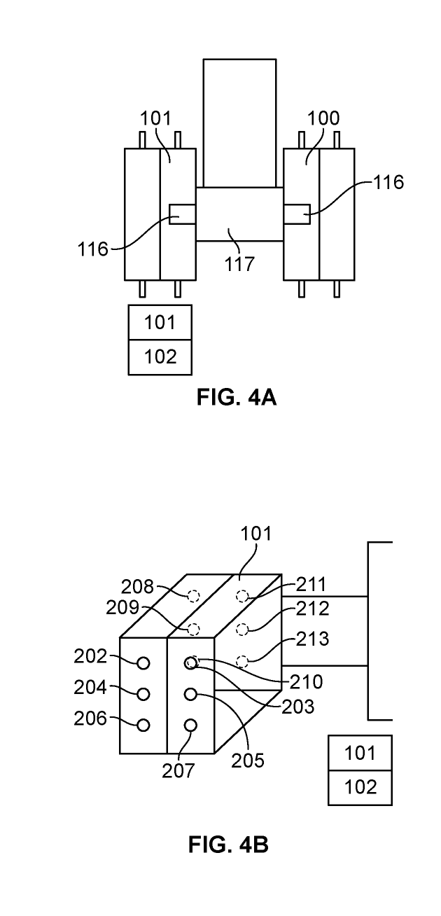

Turning now to FIG. 1, FIG. 1 is a plan view of an illustrative embodiment of the invention. As schematically depicted shown in FIG. 1, a reciprocating block 100 having a left end 102 and a right end 114 is driven back and forth, right and left by a rotating gear 106. The rotating gear has a substantially circular shape with four gear teeth 108 formed on the rotating gear along approximately one fourth of the circumference of the substantially circular shape of the rotating gear. The rotating gear 106 is attached to a rotating motor 117 (shown in FIG. 4) having a right-angle motor shaft 116. The motor shaft 116 is connected to the right-angle motor a minimal distance minimizing the length of the motor shaft to reduce torque losses associated with longer shaft lengths.

As shown in FIG. 4, the rotating gear 106 is mounted on the motor shaft 116 adjacent the motor 117 from the entry point of the shaft 116 to the motor 117 to reduce torque loss incurred that would occur if the rotating gear 106 was attached to the shaft 116 further away from the motor 117. In the present illustrative embodiment, the motor 117 is a stepper motor controlled by a processor 101 and computer readable medium 102. Thus, the present illustrative embodiment provides a substantially minimum length shaft length from where the shaft exits the motor and attaches to the rotating gear and substantially minimum torque loss due to the length of the shaft attached to the rotating gear. The rotating motor shaft is directly coupled to rotating gear 106 so that gear teeth 108 are rotated by the rotating motor shaft and during rotation, the rotating gear teeth alternately engage the upper gear teeth 104 and lower gear teeth 110 formed inside of the opening 112 in block 100. The rotating gear causes the reciprocating block to linearly translate back and forth along a longitudinal axis of a plunger 118 that is attached to the right end 114 of the block. The plunger 118 drives an injection pump used to inject chemicals into a hydrocarbon bearing formation in an oil field.

In a particular illustrative embodiment of the invention the rotating gear rotates clockwise causing rotating gear teeth 108 to alternately engage upper block gear teeth 104 and moves the reciprocating block 100 to the right along the longitudinal axis plunger 118. After the rotating gear teeth 108 exit the upper gear teeth, the rotating gear teeth alternately engage lower block gear teeth 110 and moves the reciprocating block 100 to the left along the longitudinal axis plunger 118.The plunger is used to drive an injection pump to pump injection fluids. The reciprocating block is formed having a right end 114 and a left end 102. In FIG. 1, a single plunger 118 is attached to the right end of the block.

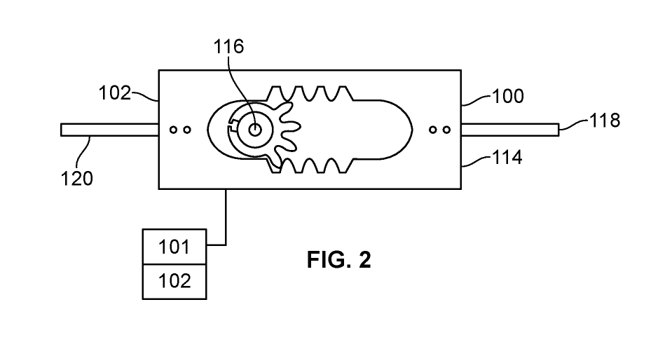

Turning now to FIG. 2, in another particular embodiment a processor 101 and computer readable medium 102 have a computer program, computer instructions stored therein that are executed by the process to control the stepper motor 117, is provided the motor 115 is a stepper motor wherein the shaft of the stepper motor is directly coupled to rotating gear 106. The stepper motor steps to rotate the motor shaft clockwise, a programmable number of degrees, less than 360 degrees and less that full rotation of the motor shaft to move the right end of the block to the right. The processor then reverses the direction of the stepper motor to rotate the gear attached to the motor shaft counterclockwise a programmable number of degrees, less than 360 degrees and less than full rotation of the motor shaft to move the left end of the lock to the left. The stepper motor enables the processor to move the block to the right a distance, for example 2 inches and move the block to the left a different distance, for example 1 inch. The gear teeth 108 are rotated by the stepper motor shaft clockwise so that the gear teeth engage the upper gear teeth 104 so that the sand lower gear teeth 110 formed inside of the block. The stepper motor motion controlled by the stepper motor causes the reciprocating block to linearly translate back and forth along a longitudinal axis of a plunger 118. In a particular embodiment, the translation to the left is 1 inch and the translation to the right is 2 inches. The stepper motor enables the processor to variably control the rotation of the gear clockwise and counterclockwise and the throw of the pump plunger or distance the block and plungers attached to the pump move. Thus, in this example of a 1-inch left translation and 2-inch right translation, a plunger on the right end of the block moves the right pump plunger 118 attached to the right end of the block 2 inches and a left pump plunger 120 attached to the left end of the pump moves a plunger attached to the left end of the pump 1 inch. It is useful to dynamically control the translation of the right and left pump plungers to dynamically control the pump rates of a first injection pump attached to the right end of the block and a second injection pump attached to the left end of the block.

In another illustrative embodiment of the invention, as schematically depicted in FIG. 2, the first plunger 118 is attached to the right end of the block and a second plunger 120 is attached the left end 102 of the block 100 are caused to linearly translate along the longitudinal axis. In a second illustrative embodiment of the invention as shown in FIG. 1B, the reciprocating block drives both plungers 102 and 120 back and forth along the common longitudinal axes of plungers 118 and 120. In the particular illustrative embodiment of the invention shown in FIG. 2 the reciprocating block drives two plungers 102 and 120 that are used to drive two fuel injection pumps.

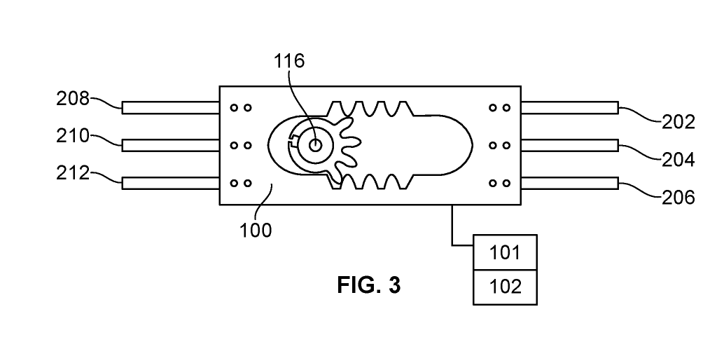

Turning now to FIG. 3, another particular illustrative embodiment of the invention is schematically depicted showing three plungers 202, 204 and 206 are attached to the right end 114 of the reciprocating block 100 and another three plungers 208, 210 and 212 are attached to the left end 114 of the reciprocating block 100. In the particular illustrative embodiment of the invention shown in FIG. 3 the reciprocating block drives 6 plungers, 3 plungers 202, 204, 206 attached to the right end of the block and 3 plungers 208, 210 and 212 attached to the left end of the block that are used to drive 6 pumps. The plungers on each end of the block are preferably aligned vertically so that looking down on the plungers only the top plunger, e.g., 202 is seen and the two plungers 204 and 206 beneath the top plunger 202 are not seen from a top view of the particular illustrative embodiment of the invention.

Turning now to FIG. 4A, is a top view another particular illustrative embodiment of the invention is schematically depicted showing six plungers 202, 203, 204, 205, 206 and 207 are attached to the right end 114 of the reciprocating block 100 and another six plungers 208, 209, 210, 211, 212, 213, 208, 209, 210, 211, 212 and 213 are attached to the left end 114 of the reciprocating block 100. In the particular illustrative embodiment of the invention shown in FIG. 3 the reciprocating block drives 12 plungers 202, 203, 204, 205, 206, 207, 208, 209, 210, 211, 212 and 213 and that are used to drive 12 pumps. The plunger line up vertically so that is a top plunger is shown, but the two other plungers below each of the top plungers are aligned beneath the top plunger and are not visible from a top view and are not shown in FIG. 4A. A right-angle shaft stepper motor 117 drives the reciprocating gear that is dynamically controlled by processor 101. FIG. 4B is an orthographic projection of the illustrative embodiment of the invention shown in FIG. 4A, showing the top plungers and two other plungers below the top plungers are shown that are not shown in FIG. 4A.

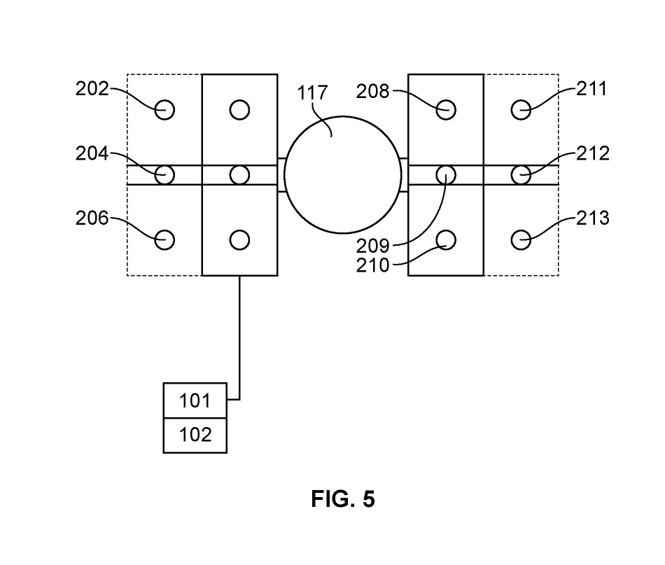

Turning now to FIG. 5, in another particular illustrative embodiment of the invention is schematically depicted showing the reciprocating block drives 12 plungers that are used to drive 12 pumps.

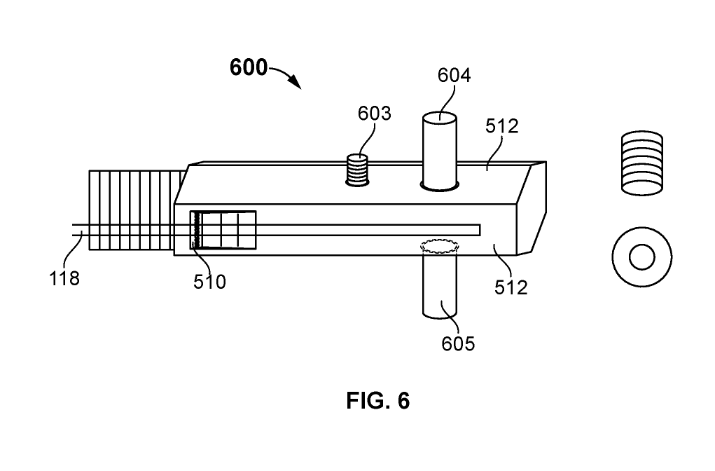

Turning now to FIG. 6, in another illustrative embodiment of the invention a pump head 600 schematically depicted. The pump head had flat surfaces 512 to facilitate maintenance and tightening of the pump head. Prior pump heads have typically been round tubular shaped and not easily engaged with a wrench for maintenance. The flat surfaces make engagement of a wrench on the flat surface easier for maintenance and tightening of the pump head. In a particular illustrative embodiment, the pump head has a hexagonal cross section along a longitudinal axis of the pump head. The hexagonal cross section of the pump head provides six flat surfaces with three sets of opposing flat surfaces for engagement with a wrench. In another embodiment the pump head has a square cross section.

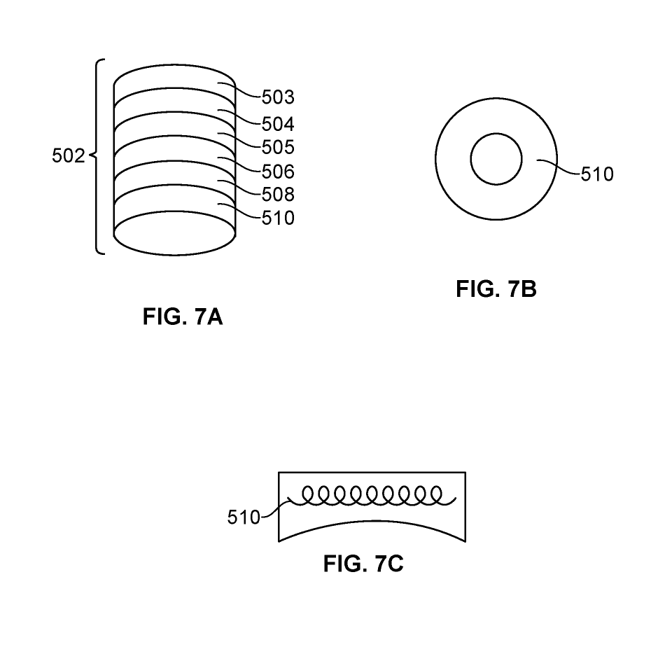

As shown in FIG. 7, a packing set 502 is provided. The packing set 502 is made up of 6 packing glands 503, 504, 505, 506, 508 and 510. In a particular embodiment, a spring-loaded packing gland is provided as a sixth gland 510 in the 6 packing glands as schematically depicted in FIG. 5. In a particular embodiment of the invention as shown in FIG. 5 the head has a hexagonal shape in cross section perpendicular to a longitudinal axis of the head through which a plunger translates through a packing gland set. In a particular illustrative embodiment of the invention, a suction check valve 605, a discharge check valve 604 and bleeder valve 603 are provided.

Turning now to FIG. 6, the packing gland is made up of six packing glands. The six packing glands are geometrically shaped to mate with adjacent packing glands to for a stacked set of six packing glands to form the packing gland set shown in FIG. 5. Packing gland 1 is flat on the bottom and concave on the top. The second, third fourth and fifth packing gland element are concave on the bottom and convex on the top. The sixth packing gland element is spring loaded and has a convex bottom and flat top.

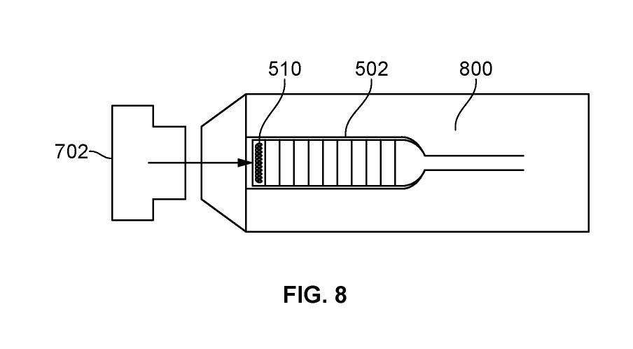

Turning now to FIGS. 7A, 7B, 7C and FIG. 8, as shown in FIGS. 7A, 7B, 7C and FIG. 8, in a particular illustrative embodiment of the invention, the sixth packing gland element 510 is a spring-loaded section that is convex on the bottom and flat on the top. The sixth packing gland element which is spring-loaded expands outwardly in a substantially radial direction 520 under pressure to packing nut 702 as the packing nut is tightened. The outward expansion of spring loaded packing glands seals the outside surface of the spring-loaded packing gland to substantially reduce leakage of injection fluid from pump head during operation of the injection pump.

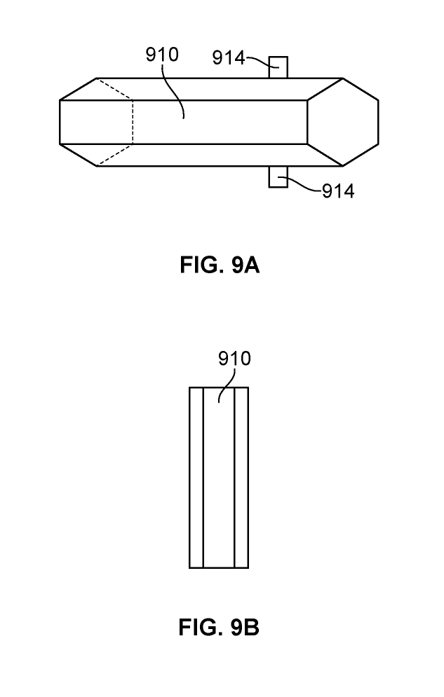

Turning now to FIGS. 9A and 9B, in another particular embodiment of the invention the reciprocating plungers drive an injection pump 800. Discharge from the injection pump to an injection line 914 attached to the injection pump is directed to an injection link atomizer 910.

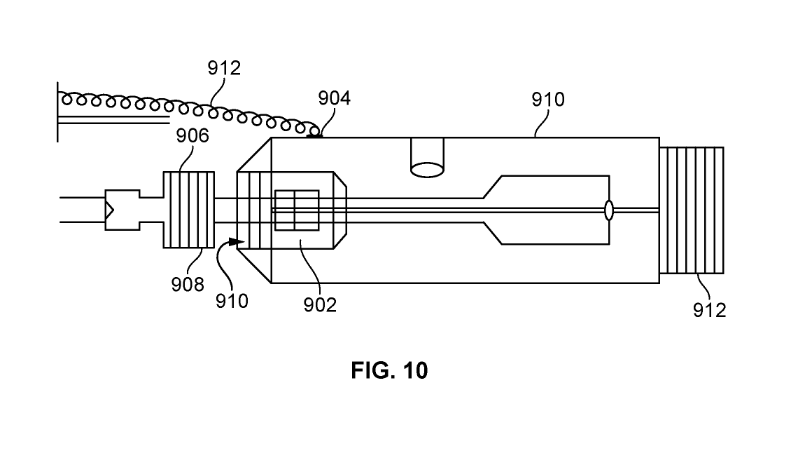

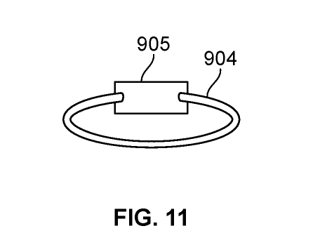

Turning now to FIG. 10, as shown in FIG. 10 a safety ring is attached through an opening in a flat surface on the hexagonal cross section of the atomizer 910. A chain 912 is attached to the safety ring on one end and a fixed member on the pump at the other end. A thermal couple fitting is provided along with a two-piece chevron packing through which a plunger 118 passes. The safety ring has a removable link 905 to enable sliding the safety ring 904 through hole formed on the flat surface of the atomizer 910. A packing set 902 such as a chevron style packing set is provided inside the atomizer 910. In another particular embodiment the packing set includes but is not limited to a spring-loaded packing gland to help seal the atomizer and prevent leaking of injection fluid. A tube 914 carries injection fluid through a thermo-coupling 906. The thermos-coupling has external threads 906 formed on one end of the thermos-couple that engage internal threads 910 formed on the atomizer and seal the connection of pumping injection fluid tube to the atomizer. A detail of the safety ring is shown in FIG. 11.

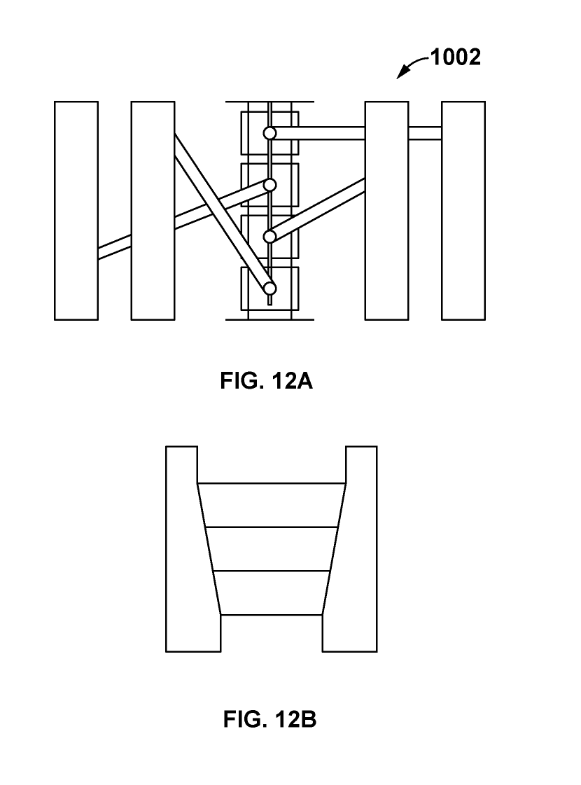

Turning now to FIG. 12A and FIG. 12B, a collapsible tank stand is schematically depicted. FIG. 12A is a schematic depiction of an illustrative embodiment of a collapsible tank stand setup and deployed and ready to support a tank. FIG. 12B is a schematic depiction of the collapsible tank stand collapsed and folded up for transport. The collapsible tank stand allows the collapsible tanks to be transport in a smaller volume when folded up. The tank stands are then unfolded and deployed after transport, saving transportation expenses by reducing the number of trucks need to transport the tank stands over the volume need to transport rigid tank stands that do not fold up and collapse.

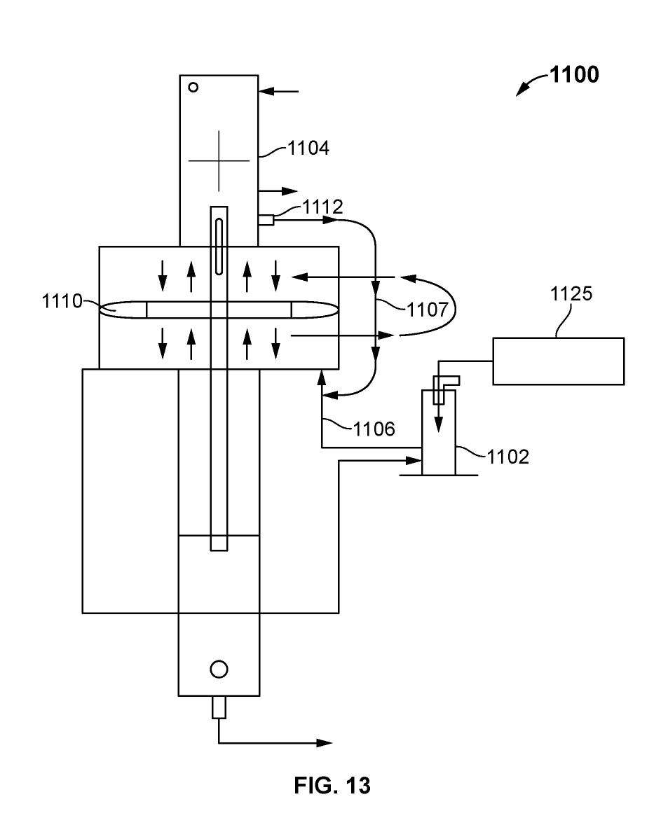

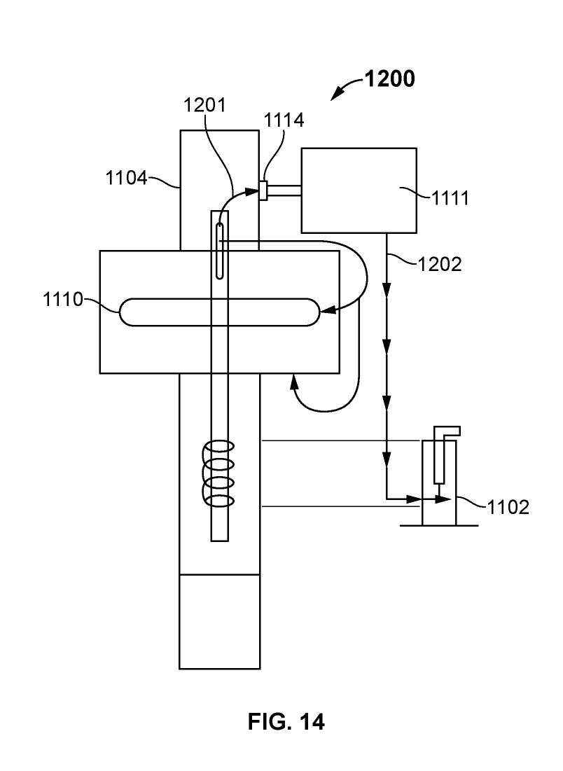

Turning now to FIG. 13 and FIG. 14, as shown in FIG. 13 and FIG. 14 in a particular illustrative embodiment, a hydraulic injection pump 1100 system driven is schematically depicted having a two-pump combination for providing a low-power consumption electrical solution to pumping injection fluid into a subterranean hydrocarbon-bearing formation. The two-pump system pumps injection fluid at a lower volume but at higher pressure that a conventional direct drive pump used to pump injection fluid into a formation. The two-pump system requires less electrical power to pump the same amount of injection fluid than using a conventional pump, such as a circulation pump. The two-pump combination is an improvement over the systems that use single convention pumps such as a circulation pump to pump a high volume at low pressure.

In a particular illustrative embodiment of the invention, the first smaller pump 1102 is used as an actuator to move the larger pump piston 1110 that pumps hydraulic fluid through hydraulic connection tube 1106 into the second larger pump 1104. In one illustrative embodiment of the invention, the smaller pump has a piston diameter of ¼ inch and the larger pump has a piston diameter of 6 inches. The small pump is caused to pump by moving a piston in the small pump controlled by a solenoid or other suitable device to cause the piston in the small pump to reciprocate at a high rate using relatively low electrical power. In a particular embodiment of the invention, the small pump piston reciprocates at 1 millisecond intervals. The small pump is driven by an electrical power source 1125. The large pump is driven by the hydraulic fluid pumped through the hydraulic connection tube 1106 from small pump.

In a particular embodiment, the small pump is powered by electrical power source 1125. The small pump requires less electrical energy to pump the mid volume high pressure injection fluid to drive the high be required to pump injection fluid using electrically energy to directly drive a conventional pump, such as a rotary pump directly. In a particular embodiment, a return line 1107 is provided to assist moving a piston 1110 in the high-power pump back up and returned to an up position after being piston has been driven down by the low-power pump.

As shown in FIG. 14, in another particular embodiment, a hydraulic fluid return line from the large pump further provides cooling of the hydraulic fluid in a cooling reservoir 1111 in the return line hydraulic circuit. The cooling circuit substantially reduces over heating of the hydraulic fluid return line when the hydraulic fluid heats up during operation. Valve 1114 is provided to return the hydraulic fluid through the return line from the high-power pump to the low-power pump. Return line 1201 returns hydraulic fluid from the cooling reservoir 111 to the small pump 1102.

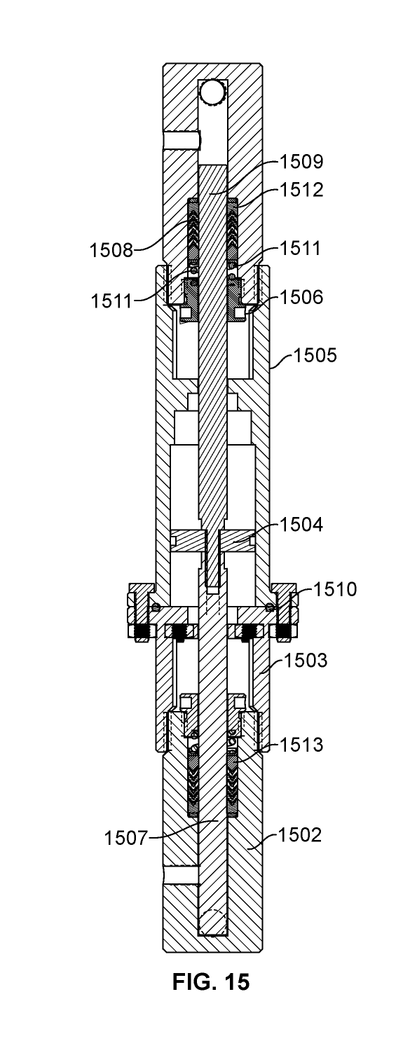

Turning now to FIG. 15, a front elevation view of an particular illustrative embodiment of a hydraulic pump is depicted. As show in FIG. 15, in a particular illustrative embodiment of the invention, a dual head chemical injection pump is provided including but not limited to a chemical injection pump body head 1502, chemical injection pump dual adapter 1503, a chemical injection pump piston 1504, a chemical injection pump reservoir 1505, a chemical injection pump seal nut 1506, a dual ½ inch plunger 1507, a seal stack assembly 1508, a main ½ inch plunger for a smaller version 1509, an O-ring 1510, a packing spring 1511, a packing washer 1512 and a spring washer 1513.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

Although the programs and other various systems, components and functionalities described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components. Such technologies are generally well known by those skilled in the art and, consequently, are not described in detail herein.

Flowcharts and Block Diagrams of the Figures show the functionality and operation of various specific embodiments of certain aspects of the present inventions. If embodied in software, each block ma represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a Turbomachine processor in a computer system or other system. The machine code may be converted from the source code, etc. If embodied in hardware, each block may represent a circuit or a number of interconnected circuits to implement the specified logical function(s).

Although the flowchart and block diagrams of the Figures show a specific order of execution, it is understood that the order of execution may differ from that which is depicted. For example, the order of execution of two or more blocks may be scrambled relative to the order shown. Also, two or more blocks shown in succession in the Figures may be executed concurrently or with partial concurrence. Further, in some embodiments, one or more of the blocks shown in the figures may be skipped or omitted. In addition, any number of counters, state variables, warning semaphores, or messages might be added to the logical flow described herein, for purposes of enhanced utility, accounting, performance measurement, or providing troubleshooting aids. It is understood that all such variations are within the scope of the present inventions.

Any logic or application described herein that comprises software or code can be embodied in any non-transitory computer-readable medium, such as computer-readable medium, for use by or in connection with an instruction execution system such as, for example, a Turbomachine processor in a computer system or other system. In this sense, the logic may comprise, for example, statements including instructions and declarations that can be fetched from the computer-readable medium and executed by the instruction execution system. In the context of the present inventions, a “computer-readable medium” may include any medium that may contain, store, or maintain the logic or application described herein for use by or in connection with the instruction execution system.

The computer-readable medium may comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random-access memory (RAM) including, for example, static random-access memory (SRAM) and dynamic random-access memory (DRAM), or magnetic random-access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

The Turbomachine processor may further include a network interface coupled to the bus and in communication with the network. The network interface may be configured to allow data to be exchanged between computer and other devices attached to the network or any other network or between nodes of any computer system or the video system. In addition to the above description of the network, it may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, the network interface may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

The processor may also include an input/output interface coupled to the bus and also coupled to one or more input/output devices, such as a display, a touchscreen, a mouse or other cursor control device, and/or a keyboard. In certain specific embodiments, further examples of input/output devices may include one or more display terminals, keypads, touchpads, scanning devices, voice or optical recognition devices, or any other devices suitable for entering or accessing data by one or more computers. Multiple input/output devices may be present with respect to a computer or may be distributed on various nodes of computer system, the system and/or any of the viewing or other devices shown in the Figures. In some embodiments, similar input/output devices may be separate from the Turbomachine processor and may interact with the Turbomachine processor or one or more nodes of computer system through a wired or wireless connection, such as through the network interface.

It is to be understood that the inventions disclosed herein are not limited to the exact details of construction, operation, exact materials or embodiments shown and described. Although specific embodiments of the inventions have been described, various modifications, alterations, alternative constructions, and equivalents are also encompassed within the scope of the inventions. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims set forth below. Accordingly, the inventions are therefore to be limited only by the scope of the appended claims. None of the claim language should be interpreted pursuant to 35 U.S.C. 112(f) unless the word “means” is recited in any of the claim language, and then only with respect to any recited “means” limitation.

1. A reciprocating injection pump comprising:
a reciprocating block driven by a rotating gear, the gear having a substantially circular shape with four gear teeth formed on the rotating gear along approximately one fourth of the substantially circular shape, the rotating gear is attached to a rotating motor, the rotating motor having a right-angle motor shaft.

2. The pump of claim 1, wherein the motor shaft is connected to the right-angle motor a minimal distance minimizing the length of the motor shaft to reduce torque losses associated with longer shaft lengths.

3. The pump of claim 1, wherein the rotating gear is mounted on the motor shaft adjacent the motor from the entry point of the shaft to the motor to reduce torque loss incurred that would occur if the rotating gear was attached further away from the motor and thus having a longer shaft length from where the shaft exits the motor and attaches to the rotating gear.

4. The pump of claim 3, wherein the rotating motor shaft is directly coupled to rotating gear so that gear teeth are rotated by the rotating motor shaft and during rotation, the rotating gear teeth alternately engage the upper gear teeth and lower gear teeth formed inside of the block, wherein the rotating gear causes the reciprocating block to linearly translate back and forth along a longitudinal axis of a plunger.

5. The pump of claim 4, wherein the plunger drives an injection pump used to inject chemicals into a hydrocarbon bearing formation in an oil field.

6. The pump of claim 5, wherein the rotating gear rotates clockwise causing rotating gear teeth to alternately engage upper block gear teeth and moves the reciprocating block to the right along the longitudinal axis plunger.

7. The pump of claim 6, wherein after the rotating gear teeth exit the upper gear teeth the rotating gear teeth alternately engage lower block gear teeth and moves the reciprocating block to the left along the longitudinal axis plunger.

8. The pump of claim 7, wherein the plunger is used to pump injection fluids.

9. The pump of claim 8, wherein the reciprocating block is formed having a right end and a left end.

10. The pump of claim 8 wherein a single plunger is attached to the right end of the block.

11. The pump of claim 1, the pump further comprising:
a processor and computer readable medium having computer instructions stored therein that are executed by the process to control the stepper motor, wherein the motor is a stepper motor wherein the shaft of the stepper motor is directly coupled to rotating gear.

12. The pump of claim 11, wherein the stepper motor steps to rotate the motor shaft clockwise a programmable number of degrees less that a 360 degrees and less that full rotation of the motor shaft to move the right end of the lock to the right, and the processor then reverses the direction of the stepper motor to rotate the motor shaft counter clock wise programmable number of degrees less than 360 degrees and less than full rotation of the motor shaft to move the left end of the lock to the left.

13. The pump of claim 12, wherein the stepper motor enables the processor to move the block to the right a distance, for example 2 inches and move the block to the left a different distance, for example 1 inch.

14. The pump of claim 12, wherein the gear teeth are rotated by the stepper motor shaft clockwise so that the gear teeth engage the upper gear teeth so that the sand lower gear teeth formed inside of the block.

15. The pump of claim 14, wherein the stepper motor motion controlled by the stepper motor causes the reciprocating block to linearly translate back and forth along a longitudinal axis of a plunger.

16. The pump of claim 15, wherein the translation to the left is 1 inch and the translation to the right is 2 inches.

17. The pump of claim 16, wherein the first plunger and a second plunger are attached the left end of the block are caused to linearly translate along the longitudinal axis and wherein the reciprocating block drives both plungers back and forth along the common longitudinal axes of plungers, wherein the reciprocating block drives two plungers that are used to drive two fuel injection pumps.

18. The pump of claim 17, wherein three plungers are attached to the right end of the reciprocating block and another three plungers are attached to the left end of the reciprocating block the reciprocating block drives 6 plungers that are used to drive 6 pumps.

19. The pump of claim 17, wherein six plungers are attached to the right end of the reciprocating block and another six plungers are attached to the left end of the reciprocating block, wherein the reciprocating block drives 12 plungers and that are used to drive 12 pumps.

20. A method comprising:
rotating a gear in a reciprocating block driven by a rotating gear, the gear having a substantially circular shape with four gear teeth formed on the rotating gear along approximately one fourth of the substantially circular shape, the rotating gear is attached to a rotating motor, the rotating motor having a right-angle motor shaft, wherein the motor shaft is connected to the right-angle motor a minimal distance minimizing the length of the motor shaft to reduce torque losses associated with longer shaft lengths, wherein the rotating motor shaft is directly coupled to rotating gear so that gear teeth are rotated by the rotating motor shaft and during rotation, the rotating gear teeth alternately engage the upper gear teeth and lower gear teeth formed inside of the block, wherein the rotating gear causes the reciprocating block to linearly translate back and forth along a longitudinal axis of a plunger, wherein the rotating gear rotates clockwise causing rotating gear teeth to alternately engage upper block gear teeth and moves the reciprocating block to the right along the longitudinal axis plunger and wherein after the rotating gear teeth exit the upper gear teeth the rotating gear teeth alternately engage lower block gear teeth and moves the reciprocating block to the left along the longitudinal axis plunger and wherein the stepper motor steps to rotate the motor shaft clockwise a programmable number of degrees less that a 360 degrees and less that full rotation of the motor shaft to move the right end of the lock to the right, and the processor then reverses the direction of the stepper motor to rotate the motor shaft counter clock wise programmable number of degrees less than 360 degrees and less than full rotation of the motor shaft to move the left end of the lock to the left.
